(19) United States
(12) Patent Application Publication
(10) Pub. No.: US 2025/0145763 A1
(43) Pub. Date: May 8, 2025

(54) PEKK MANUFACTURING PROCESS

(71) Applicant: ARKEMA FRANCE, COLOMBES (FR)

(72) Inventors: Guillaume LE, Serquigny (FR); Laura LUIZ, Serquigny (FR); Martin HERBLOT, KING OF PRUSSIA, PA (US); Jérôme AMSTUTZ, PIERRE-BENITE (FR)

(73) Assignee: ARKEMA FRANCE, COLOMBES (FR)

(21) Appl. No.: 18/503,546

(22) Filed: Nov. 7, 2023

(51) Int. Cl. C08G 61/12

(52) U.S. Cl. CPC C08G 61/127; C08G 2261/3442; C08G 2261/45

(57) ABSTRACT

The invention relates to a process for manufacturing a polyether ketone ketone, which involves placing in contact an aromatic ether which is diphenyl ether, 1,3-bis(4-phenoxybenzoyl)benzene, 1,4-bis(4-phenoxybenzoyl)benzene or a mixture thereof, an acyl chloride which is isophthaloyl chloride, terephthaloyl chloride, or a mixture thereof, a Lewis acid, and a first fraction s₁ of a reaction solvent, so as to form a premix at a temperature T₀ less than or equal to 25° C. and placing the premix formed at T₀ in contact with a fraction s₂ of the reaction solvent, the fraction s₂ of reaction solvent being preheated, so as to form a reaction mixture heated to a temperature T₁.

### TECHNICAL FIELD

The invention relates to the field of polyether ketone ketones.

More particularly, the invention relates to a process for manufacturing polyether ketone ketone by electrophilic precipitating polymerization.

The invention also relates to the polymer, notably in the form of a porous flake powder, which may be obtained via said process.

### PRIOR ART

It is known practice, notably from U.S. Pat. No. 3,791,890, to manufacture polyether ketone ketone electrophilically from a mixture of isophthaloyl chloride and terephthaloyl chloride (acyl chlorides), reacted with diphenyl ether (aromatic ether) in the presence of aluminium chloride (Lewis acid) and using ortho-dichlorobenzene as reaction solvent. Example 3 of U.S. Pat. No. 3,791,890 describes the preparation of a premix comprising acyl chlorides, diphenyl ether and aluminium chloride in a first fraction of ortho-dichlorobenzene at a temperature of about −5° C. The reaction is then initiated by dispersing this premix in a second fraction of ortho-dichlorobenzene preheated to 100° C. This sequence of first preparing a cold premix and then dispersing the premix in a preheated reaction solvent allows the temperature of the reaction mixture to rise extremely rapidly. Although the mechanisms taking place in the reaction medium are not fully understood, U.S. Pat. No. 3,791,890 indicates that this is considered to enable the polymer particles being formed to be separated, facilitate the polymerization reaction, and prevent the coagulation of the particles into a gelatinous mass characteristic of this polymerization reaction.

As shown in the experimental section, the polymers obtained via a process according to this prior art in which a premix is dispersed in the reaction solvent at a temperature characterized in the present invention as high, preferentially at least about 100° C., have several drawbacks. Firstly, chromatographic analysis of such polymers of the prior art has revealed that they comprise an appreciable amount of low molecular weight oligomers, notably oligomers with a weight of 500 g/mol to 3000 g/mol. However, these low molecular weight oligomers may have a negative impact on the processing and/or on certain thermal characteristics of the polymer. For example, the presence of low molecular weight oligomers may be the cause of defects, notably black spots, on objects obtained by extrusion. Furthermore, deposits of degraded material may form in the dies used for the extrusion. Moreover, these low molecular weight oligomers, notably those with a weight of 500 g/mol to 3000 g/mol, are difficult to extract even by advanced extraction methods.

Secondly, such polymers are in the form of large particles with a fairly heterogeneous size distribution, which is detrimental for many applications in which the powder must be able to flow readily and the particles must behave homogeneously.

An alternative process for avoiding the formation of a gelatinous mass during polymerization is also known from WO 9 523 821. According to said process, a polymer dispersant can be used to prevent coagulation of a tacky polymer product formed during polymerization. Said document explains that the tacky polymer product is in fact due to the complex formed by a low molecular weight polymer with Lewis acid at the start of the polymerization reaction and which precipitates in the form of a gel that coats the walls of the reactor and the stirrer. Among the dispersants, the patent denotes, for example, compounds having as pendant group a moiety having the formula:

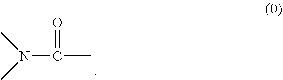

It is also known practice, notably from US 2012/0263953, to use control agents acting as dispersants, and notably the use of benzoic acid and derivatives thereof.

However, the addition of a dispersant has a number of drawbacks. The use of certain dispersants, notably those with a moiety of formula (0) as illustrated above, leads to over-consumption of Lewis acid in the process, said acid also forming a complex with the dispersant. In addition, this complicates the management of the process effluents, notably the exploitation/recycling of the effluent containing the Lewis acid. Finally, the dispersant cannot be completely removed from the manufactured polymer and may have a detrimental effect on the thermal stability of the polymer.

Thus, there is currently a need to improve the processes for manufacturing polyether ketone ketone according to the prior art so as to reduce the amount of low molecular weight molecules in the polymer and/or so as to obtain a powder with a more homogeneous distribution, while continuing to limit the coagulation of the polymer particles into a gelatinous mass characteristic of the electrophilic polymerization reaction of the polyether ketone ketone.

### OBJECTS OF THE INVENTION

One object of the invention is to propose a simple process for manufacturing polyether ketone ketone which enables fouling of the polymerization reactor to be limited.

Another object is, at least according to certain embodiments, to propose a process having a good polymer manufacturing yield.

Another object of the invention is, at least according to certain embodiments, to propose a process allowing a polymer to be manufactured which has fewer low molecular weight molecules/oligomers, notably fewer molecules/oligomers with a molecular weight of less than 3000 g/mol, and more particularly fewer molecules/oligomers with a molecular weight ranging from 500 g/mol to 3000 g/mol, than the abovementioned polymers of the prior art.

Another object of the invention is, at least according to certain embodiments, to propose a process for obtaining polymer particles with a sufficiently homogeneous size distribution.

Another object of the invention is, at least according to certain embodiments, to propose a process for obtaining polymer particles of sufficiently small size.

Another object of the invention is, at least according to certain embodiments, to propose a process for obtaining polymer particles not comprising a dispersant, not even in trace amount.

Another object of the invention is to propose a polymer, notably in powder form, which is easier to handle and/or which enables the production of parts with fewer defects, notably for objects obtained via extrusion processes.

### SUMMARY OF THE INVENTION

The invention relates to a process for manufacturing a polyether ketone ketone. This process involves:
placing in contact an aromatic ether which is diphenyl ether, 1,3-bis(4-phenoxybenzoyl)benzene, 1,4-bis(4-phenoxybenzoyl)benzene or a mixture thereof, an acyl chloride which is isophthaloyl chloride, terephthaloyl chloride, or a mixture thereof, a Lewis acid, and a first fraction s₁ of a reaction solvent, so as to form a premix at a temperature T₀ less than or equal to 25° C.;
placing in contact the premix formed at T₀ with a fraction s₂ of the reaction solvent, the fraction s₂ of reaction solvent being preheated, so as to form a reaction mixture brought to a temperature T₁ ranging from 40° C. to 80° C.

Optionally, the process involves maintaining the formed premix at T₀ prior to forming the reaction mixture brought to T₁.

Optionally, the process involves maintaining the formed reaction mixture at T₁.

According to certain embodiments, the reaction solvent is chosen from the group consisting of: ortho-dichlorobenzene, 1,2,4-trichlorobenzene, 1,2,3-trichlorobenzene, ortho-difluorobenzene, and mixtures thereof. Preferably, the reaction solvent is ortho-dichlorobenzene.

According to certain embodiments, the Lewis acid is chosen from the group consisting of: aluminium trichloride, aluminium tribromide, antimony pentachloride, antimony pentafluoride, indium trichloride, gallium trichloride, boron trichloride, boron trifluoride, zinc chloride, ferric chloride, stannic chloride, titanium tetrachloride and molybdenum pentachloride, and mixtures thereof. Preferably, the Lewis acid is aluminium trichloride.

Preferably, the aromatic ether consists essentially of, or consists of, 1,4-bis(4-phenoxybenzoyl)benzene.

According to certain embodiments, s₂≥0.25 According to certain embodiments, s₁≥0.25. According to certain embodiments, s₁≥0.25 and s₂≥0.25.

According to certain embodiments, s₁+s₂≥0.75.

According to certain embodiments, s₁+s₂=1.

According to certain embodiments, T₁ ranges from 40° C. to 52° C., or T₁ ranges from 52° C. to 60° C., or T₁ ranges from 60° C. to 68° C., or T₁ ranges from 68° C. to 80° C.

According to certain embodiments, the reaction mixture is brought to and optionally maintained at T₁ until the reaction mixture formed has a fraction of molecular masses strictly less than 500 g/mol in PMMA equivalent which is less than or equal to 50%, preferentially less than or equal to 25%, and more preferentially less than or equal to 15%.

According to certain embodiments, the reaction medium is brought to and optionally maintained at a temperature T₂ ranging from a temperature at least 10° C. higher than T₁ to a temperature of 120° C., after the step of forming and optionally maintaining the reaction mixture at the temperature T₁.

According to certain embodiments, the process comprises a step for purifying the mixture of products obtained at the end of polymerization.

According to certain embodiments, a chain-limiting agent is added before the step of forming the reaction mixture brought to a temperature T₁.

According to certain embodiments, the mole ratio of aromatic ether(s) relative to the reaction solvent which has been introduced in total into the reaction mixture is: from 0.005 to 0.030, preferentially: from 0.008 to 0.025 and very preferably: from 0.010 to 0.022.

According to certain embodiments, the premix formed at T₀ is dispersed in all or part of the fraction s₂ of the preheated reaction solvent to form the reaction mixture brought to T₁.

According to certain embodiments, the step of placing the premix in contact with the fraction s₂ of preheated reaction solvent to form the reaction mixture brought to T₁ is performed with stirring, and preferentially using a dual flow stirring means.

According to certain embodiments, the polyether ketone ketone obtained via the process consists of repeating units of formula (I) and of formula (II), the ratio of units of formula (II) relative to the units of formula (I) being from 55:45 to 95:5,
the unit of formula (I) having the chemical formula:

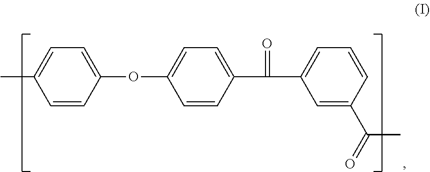

and the unit of formula (II) having the chemical formula:

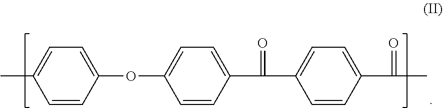

The invention also relates to a polyether ketone ketone, notably in powder form, derived therefrom. This polyether ketone ketone is advantageously obtained via the electrophilic process according to the invention.

The polyether ketone ketone consists of three molecular mass fractions A, B and C, in which A represents the percentage fraction of molecular masses strictly below 500 g/mol in PMMA equivalent, B represents the percentage fraction of molecular masses ranging from 500 g/mol to 3000 g/mol in PMMA equivalent, and C represents the percentage fraction of molecular masses strictly above 3000 g/mol in PMMA equivalent. It is characterized in that:

A+B≤5.0% and A+B+C=100%.

According to certain embodiments, B≤4.0%, preferentially B≤3.5%, and more preferably B≤3.3%.

According to certain embodiments, the polyether ketone ketone has an inherent viscosity of greater than or equal to 0.4 dl/g, preferentially greater than or equal to 0.5 dl/g, preferentially greater than or equal to 0.6 dl/g, and more preferentially greater than or equal to 0.7 dl/g. According to certain embodiments, the polyether ketone ketone has an inherent viscosity of less than or equal to 2 dl/g, and preferentially less than or equal to 1.5 dl/g.

According to certain embodiments, the polyether ketone ketone consists of repeating units of formula (I) and of formula (II), the ratio of units of formula (II) relative to the units of formula (I) being from 55:45 to 95:5.

According to certain embodiments, the polyether ketone ketone does not comprise any dispersant.

According to certain embodiments, the polyether ketone ketone powder has a mass proportion of particles with a size strictly greater than 1000 micrometres of less than or equal to 50%, as obtained by screening using a sieve with a mesh size equal to 1 millimetre.

According to certain embodiments, the powder has a mass proportion of particles with a size strictly greater than 1000 micrometres of less than or equal to 10%, and preferentially less than or equal to 5%. According to a first variant, the mass proportion of particles ranging in size from 315 micrometres to 1000 micrometres is greater than or equal to 50%, and preferentially greater than or equal to 80%. According to this first variant, the powder preferentially has a mass proportion of particles with a size strictly less than 315 micrometres of less than or equal to 10%. According to a second variant, the mass proportion of particles strictly smaller than 630 micrometres is greater than or equal to 50%, preferentially greater than or equal to 70%, and more preferably greater than or equal to 85%.

According to certain embodiments, the powder has a tapped density of greater than or equal to 180 kg/m³ and less than or equal to 400 kg/m³.

### FIGURES

FIG. 1 represents the mass proportions (y-axes, expressed in percent) for different particle size ranges (x-axes, expressed in millimetres, measured using sieves, for tests #1 (55° C.), #2 (65° C.) and #3 (90° C.; comparative) according to Example 1.

FIG. 2 represents the fraction A (y-axes, expressed in %) of molecular masses strictly less than 500 g/mol for the product mixtures obtained according to Example 2 at different polymerization maintenance times at 65° C. (x-axes, expressed in minutes) after formation of the reaction mixture at 65° C.

### DETAILED DESCRIPTION OF THE INVENTION

The polyether ketone ketones, also known as PEKKs, prepared according to the process of the invention consist essentially of, preferentially consist of:

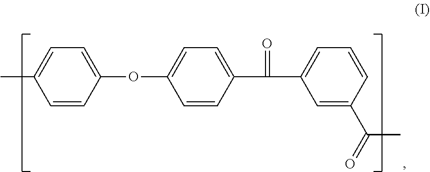

also denoted as the isophthalic unit or by the initial “I”;

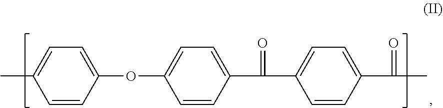

also denoted as the terephthalic unit or by the initial “T”; and,
a mixture thereof.

According to certain embodiments, the polyether ketone ketones manufactured according to the invention consist essentially of, i.e. comprise, at least 95 mol %, preferably at least 98 mol %, of the repeating units of formula (I) and/or of formula (II), optionally considered as a whole, relative to the total number of moles of the repeating units of the polymer.

According to certain embodiments, the polyether ketone ketones manufactured according to the invention consist essentially of, or consist of, repeating units of formula (II) and optionally repeating units of formula (I), the proportion of units of formula (II) relative to the units of formula (I), noted as the ratio T:I, being from 50:50 to 100:0. The ratio T:I may notably be from 50:50 to 55:45, or from 55:45 to 65:35, or from 65:35 to 75:25, or from 75:25 to 85:15, or from 85:15 to 95:5, 95:5 to 100:0. According to certain embodiments, the polyether ketone ketones consist of repeating units of formula (I) and of formula (II), the proportion of units of formula (II) relative to the units of formula (I), noted as the ratio T:I, being from 55:45 to 95:5.

According to certain embodiments, the polyether ketone ketones according to the invention consist essentially of, or consist of, repeating units (I) and optionally repeating units of formula (II), with a ratio T:I of from 0:100 to 50:50. Notably the ratio T:I may be from 0:100 to 5:95, or from 5:95 to 10:90, or from 10:90 to 20:80, or from 20:80 to 30:70, or from 30:70 to 40:60, or from 40:60 to 50:50.

The polymerization reaction involved is a polycondensation reaction involving electrophilic substitution between one or more aromatic ethers with one or more acyl chlorides, in the presence of a Lewis acid and optionally a chain-limiting agent in a reaction solvent. The polymerization reaction is also precipitating due to the fact that the polymer formed precipitates from the reaction medium. It is also exothermic. Hydrogen chloride is produced during the polycondensation.

The invention consists in preparing a premix comprising the aromatic ether(s), the acyl chloride(s) and the Lewis acid at a sufficiently low temperature so that the polymerization reaction remains extremely limited or is even inhibited in the premix. The polymerization reaction is then activated by dispersing the premix with all or some of the preheated reaction solvent in such a way that the reaction mixture immediately or virtually immediately reaches a moderate polymerization temperature of 40° C. to 80° C. The inventors have noted, entirely surprisingly, that performing the start of the polymerization reaction under these moderate temperature conditions makes it possible i) to obtain a polymer with a lower proportion of low molecular weight molecules than for the processes of the prior art in which the polymerization reaction is performed by placing the premix in contact with a reaction solvent preheated to 100° C., ii) while at the same time ensuring limited fouling by gel formation in the polymerization reactor, and iii) obtaining polymer particles of smaller size and with a more homogeneous size distribution. The lower proportion of low molecular weight molecules is an entirely counter-intuitive result for a precipitating polymerization performed at least partly at a lower temperature (40° C. to 80° C. instead of 100° C.). Specifically, a person skilled in the art would have expected the species present in the reaction medium to be less soluble at lower temperatures and the probability of reaction between the reactive species to be lower, thus producing a polymer with a higher proportion of low molecular weight molecules.

The acyl chloride is chosen from the group consisting of: terephthaloyl chloride, isophthaloyl chloride, and a mixture thereof.

A certain number of measures may be taken to ensure that the acyl chloride(s) used have a satisfactory degree of purity. Specifically, acyl chlorides are readily hydrolysable species and may notably contain a certain amount of hydrolysed species as impurities if they are not stored and/or handled under appropriate conditions.

In particular, the acyl chlorides must not be placed in contact with water and/or a humid atmosphere at any time before being placed in the reactor. It may thus be advantageous to store the acyl chlorides in a sealed container without contact with ambient air, or alternatively in a container containing dry air. Advantageously, the acyl chlorides may be kept under an atmosphere of dry nitrogen before being placed in the reactor so as to avoid any contact with the ambient air.

The aromatic ether is chosen from the group consisting of: diphenyl ether, 1,3-bis(4-phenoxybenzoyl)benzene, 1,4-bis(4-phenoxybenzoyl)benzene or a mixture thereof.

1,3-Bis(4-phenoxybenzoyl)benzene has the chemical formula:

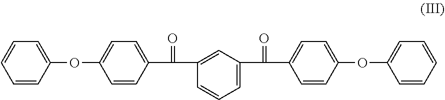 [SMILES: O=C(c1ccc(Oc2ccccc2)cc1)c1cccc(C(=O)c2ccc(Oc3ccccc3)cc2)c1]

1,4-Bis(4-phenoxybenzoyl)benzene has the chemical formula:

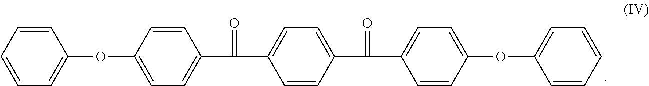 [SMILES: O=C(c1ccc(Oc2ccccc2)cc1)c1ccc(C(=O)c2ccc(Oc3ccccc3)cc2)cc1]

According to certain embodiments, the aromatic ether or the mixture of aromatic ethers comprises at least 60 mol %, or at least 70 mol %, or at least 80 mol %, or at least 90 mol %, or at least 95 mol %, or at least 99 mol % of 1,3-bis(4-phenoxybenzoyl)benzene and/or 1,4-bis(4-phenoxybenzoyl)benzene, optionally considered as a whole, relative to the total number of moles of aromatic ether(s).

According to certain embodiments, a mixture of aromatic ethers is used. It consists essentially of, or consists of, 1,3-bis(4-phenoxybenzoyl)benzene and 1,4-bis(4-phenoxybenzoyl)benzene.

According to certain embodiments, a mixture of aromatic ethers is used. It consists of 1,4-bis(4-phenoxybenzoyl)benzene and diphenyl ether. The mixture may comprise up to 20 mol %, preferentially up to 10 mol %, more preferably up to 5 mol %, and extremely preferably up to 1 mol % of diphenyl ether, relative to the total number of moles of aromatic ethers.

According to certain embodiments, the aromatic ether consists essentially of, or consists of, 1,4-bis(4-phenoxybenzoyl)benzene.

According to certain embodiments, a mixture of aromatic ethers is used. It consists of 1,3-bis(4-phenoxybenzoyl)benzene and diphenyl ether. The mixture may comprise up to 20 mol %, preferentially up to 10 mol %, more preferably up to 5 mol %, and extremely preferably up to 1 mol % of diphenyl ether, relative to the total number of moles of aromatic ethers.

According to certain embodiments, the aromatic ether consists essentially of, or consists of 1,3-bis(4-phenoxybenzoyl)benzene.

According to certain embodiments, the aromatic ether consists essentially of, or consists of 1,4-bis(4-phenoxybenzoyl)benzene. A polyether ketone ketone having a ratio T:I of from 50:50 to 100:0 may be obtained by means of mixing isophthaloyl chloride and terephthaloyl chloride and by adjusting the isophthaloyl chloride/terephthaloyl chloride ratio.

According to certain embodiments, the acyl chloride is terephthaloyl chloride only. A polyether ketone ketone having a ratio of T:I of from 50:50 to 100:0 may be obtained by means of a mixture consisting essentially of or consisting of 1,3-bis(4-phenoxybenzoyl)benzene and 1,4-bis(4-phenoxybenzoyl)benzene and by adjusting the ratio of 1,3-bis(4-phenoxybenzoyl)benzene to 1,4-bis(4-phenoxybenzoyl)benzene.

In a similar manner, according to certain embodiments, the aromatic ether consists essentially of, or consists of 1,3-bis(4-phenoxybenzoyl)benzene (or, respectively, the acyl chloride is solely isophthaloyl chloride). A polyether ketone ketone having a ratio T:I of from 0:100 to 50:50 may be obtained by adjusting the ratio of isophthaloyl chloride to terephthaloyl chloride (or, respectively, by adjusting the ratio of 1,3-bis(4-phenoxybenzoyl)benzene to 1,4-bis(4-phenoxybenzoyl)benzene).

The Lewis acid may be chosen from the group consisting of: aluminium trichloride, aluminium tribromide, antimony pentachloride, antimony pentafluoride, indium trichloride, gallium trichloride, boron trichloride, boron trifluoride, zinc chloride, ferric chloride, stannic chloride, titanium tetrachloride and molybdenum pentachloride, and mixtures thereof.

Preferentially, only one type of Lewis acid is used in the polymerization reaction.

Among the Lewis acids mentioned above, aluminium trichloride, boron trichloride, aluminium tribromide, titanium tetrachloride, antimony pentachloride, ferric chloride, gallium trichloride and molybdenum pentachloride are preferred.

Aluminium trichloride is particularly preferred.

Preferably, the Lewis acid is added in solid form. Alternatively, it may also be added in suspension or colloid form, i.e. as a heterogeneous mixture of solid particles of Lewis acid in a solvent, or in solution form, i.e. as a homogeneous mixture in a solvent. The solvent for the suspension/colloid or for the solution is advantageously the reaction solvent.

According to certain variants, the Lewis acid is added in particulate form, such as in powder form (having, for example, a Dv80 of less than 1 mm and preferably a Dv50 of less than 0.5 mm). The parameters Dv80 and Dv50 are, respectively, the particle sizes at the 80th and 50th percentiles (by volume) of the cumulative particle size distribution of the Lewis acid particles. These parameters may notably be determined by screening.

The Lewis acid used in the process according to the invention preferably has a degree of purity such that it comprises less than 0.1% by weight of insoluble matter, and more preferentially less than 0.05% by weight of insoluble matter, as measured gravimetrically, when it is introduced with stirring into water at a concentration of 11% by weight at 20° C. and substantially dissolved.

The reaction solvent may be chosen from the group consisting of: ortho-dichlorobenzene, 1,2,4-trichlorobenzene, 1,2,3-trichlorobenzene, ortho-difluorobenzene, and mixtures thereof.

ortho-Dichlorobenzene is particularly preferred.

The reaction solvent preferably contains less than 500 ppm by weight of water so as to limit the hydrolysis reaction of the acyl chloride or of the mixture of acyl chlorides. Advantageously, the reaction solvent contains less than 250 ppm by weight of water, preferably less than 150 ppm by weight of water, and more preferentially less than 100 ppm by weight of water.

In preferred variants, the aromatic ether or the mixture of aromatic ethers also preferably contains less than 500 ppm by weight of water so as to limit the hydrolysis reaction of the acyl chloride or the mixture of acyl chlorides. The same ranges of preferred values as for the reaction solvent apply mutatis mutandis to the aromatic ether or to the mixture of aromatic ethers.

In even more preferred variants, the reaction solvent and the aromatic ether or the mixture of aromatic ethers together comprise less than 500 ppm by weight of water so as to limit the hydrolysis reaction of the acyl chloride or the mixture of acyl chlorides. The same ranges of preferred values as for the reaction solvent apply mutatis mutandis to the reaction solvent and the aromatic ether or mixture of aromatic ethers, under consideration as a whole.

In order to ensure the absence of traces of water in a reactor, the process advantageously comprises a preliminary drying step, i.e. reducing the water content of the reaction solvent and/or of the aromatic ether or the mixture of aromatic ethers, before placing them in contact with the acyl chloride or with the mixture of acyl chlorides. Means for performing this preliminary drying step include, for example, distillation of the chemical compounds, or placing them in contact with molecular sieves or even placing them in contact with a dehydrating agent such as a small amount of aluminium chloride.

The use of one or more chain-limiting agents in the reaction medium is optional. Their addition allows better control of the degree of polymerization and thus of the viscosity of the polymer to be manufactured. It also allows better control of the chain ends of the polymer and, where appropriate, ensures better stability, notably better thermal stability, of the polymer.

Two types of chain-limiting agent may be used: a nucleophilic chain-limiting agent or an electrophilic chain-limiting agent.

According to certain embodiments, the chain-limiting agent is a nucleophilic chain-limiting agent. The nucleophilic chain-limiting agent may notably be chosen from compounds having the following chemical formula:

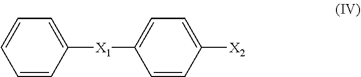

in which:
X₁ represents: a covalent bond, —O—, or —S—; and
X₂ represents C₆H₅CO or C₆H₅SO₂;
or of the following chemical formula:

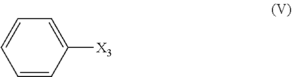

in which:
X₃ is a halogen, an alkyl group or an alkoxy group containing from 1 to 10 carbon atoms.

Preferentially, the nucleophilic chain-limiting agent is chosen from the group consisting of: 4-phenoxybenzophenone, 4-phenoxydiphenyl sulfone, anisole, fluorobenzene, chlorobenzene, biphenyl, toluene, and a mixture thereof.

A particularly advantageous nucleophilic chain-limiting agent is 4-phenoxybenzophenone.

According to certain embodiments, the chain-limiting agent is an electrophilic chain-limiting agent. The electrophilic chain-limiting agent may notably be chosen from compounds of the following formula:

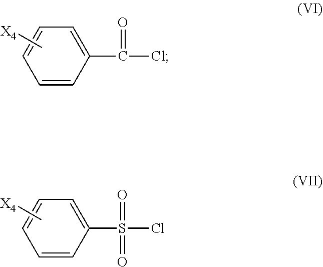

in which:
X₄ represents: a hydrogen atom, a halogen atom, an alkyl or alkoxy group containing from 1 to 10 carbon atoms, a nitro, C₆H₅CO or C₆H₅SO₂ group; or of the following formula:

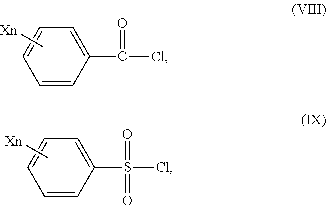

in which:
Xₙ represents n groups, n being an integer chosen between 2 and 5, each group being independently chosen from: a halogen atom, an alkyl or alkoxy group containing from 1 to 10 carbon atoms, a nitro group, C₆H₅CO or C₆H₅SO₂.

Preferentially, the electrophilic chain-limiting agent is chosen from the group consisting of: benzoyl chloride, acetyl chloride, 3,5-dichlorobenzoyl chloride, 3,5-difluorobenzoyl chloride, p-fluorobenzoyl chloride, p-chlorobenzoyl chloride, p-methoxybenzoyl chloride, benzenesulfonyl chloride, p-chlorobenzenesulfonyl chloride, p-methylbenzenesulfonyl chloride, 4-benzoylbenzoyl chloride, and a mixture thereof.

Advantageously, the chain-limiting agent is an electrophilic chain-limiting agent chosen from benzoyl chloride, p-fluorobenzoyl chloride, 3,5-difluorobenzoyl chloride, or a mixture thereof. These chain-limiting agents are readily measured out as they are in liquid form at room temperature, have a low cost price and ensure good thermal stability of the polymer.

According to certain embodiments, benzoyl chloride is used as chain-limiting agent.

According to certain embodiments, p-fluorobenzoyl chloride is used as chain-limiting agent.

According to certain embodiments, 3,5-difluorobenzoyl chloride is used as chain-limiting agent.

In certain embodiments in which a chain-limiting agent is used, this chain-limiting agent may be added in any step of the process.

According to certain embodiments, all or some of the chain-limiting agent may be added with the other chemical species to form the premix at T₀ or during the step of maintaining the premix at T₀.

Advantageously, the chain-limiting agent may be added to the reaction medium in its entirety, before the step of forming the reaction mixture heated to a temperature T₁.

The use of a dispersant in the reaction medium is optional and has no particular advantage. Specifically, the process according to the invention generally allows the use of such agents to be dispensed with since it enables the fouling to be minimized by bringing the reaction medium from T₀ to T₁ almost immediately. According to advantageous embodiments, no dispersant is added to the reaction medium. This notably has several advantages: it avoids over-consumption of the Lewis acid introduced and/or facilitates the upgrading of the process effluents, notably the effluent containing the Lewis acid, and/or allows a polyether ketone ketone to be manufactured free of any trace of dispersant.

Since the polymerization reaction is a polycondensation, the aromatic ether or mixture of aromatic ethers is introduced into the reaction medium under conditions which are substantially stoichiometric relative to the acyl chloride or mixture of acyl chlorides. The mole ratio of aromatic ether(s) relative to the acyl chloride(s) which have been introduced in total into the reaction medium at the end of the step of placing in contact to form the premix at T₀ is preferentially from 0.9:1.1 to 1.1:0.9.

According to advantageous embodiments, the aromatic ether(s) are introduced in excess relative to the acyl chloride(s), preferentially with a mole ratio of aromatic ether(s) relative to acyl chloride(s) of 1.001 to 1.1. In these embodiments, if a chain-limiting agent is used, it is preferentially an electrophilic chain-limiting agent, for example, and advantageously, benzoyl chloride or p-fluorobenzoyl chloride or 3,5-difluorobenzoyl chloride.

The mole ratio of Lewis acid relative to the aromatic ether(s) which have been introduced in total into the reaction medium at the end of the step of placing in contact to form the premix at T₀ is preferentially such that the Lewis acid is in slight excess relative to the total ether functions, and optionally ketone functions, of the aromatic ether or mixture of aromatic ethers and the acyl chloride functions of isophthaloyl chloride, terephthaloyl chloride, or a mixture thereof. The mole ratio of Lewis acid relative to the aromatic ether(s) which have been introduced in total into the reaction medium at the end of the step of placing in contact to form the premix at T₀ is preferentially from 5.0 to 7.0, and very preferentially from 5.1 to 6.5, in the embodiments in which the aromatic ether consists essentially of, or consists of, 1,3-bis(4-phenoxybenzoyl)benzene, 1,4-bis(4-phenoxybenzoyl)benzene, or a mixture thereof.

The mole ratio of aromatic ether(s) relative to the reaction solvent(s) which have been introduced in total into the reaction medium at the end of the polymerization is preferentially at least equal to 0.005, very preferentially greater than or equal to 0.008, and more preferably greater than or equal to 0.010.

The mole ratio of aromatic ether(s) relative to the reaction solvent(s) which have been introduced in total into the reaction medium at the end of the polymerization is greater than or equal to 0.010, or greater than or equal to 0.011, or greater than or equal to 0.012, or greater than or equal to 0.013, or greater than or equal to 0.014, or greater than or equal to 0.015, or greater than or equal to 0.016, or greater than or equal to 0.17. In contrast, given that the less reaction solvent the reaction medium contains, the more likely it is to form fouling during polymerization, especially in the absence of dispersant, the mole ratio of aromatic ether(s) relative to the reaction solvent(s) which have been introduced in total into the reaction medium at the end of polymerization is preferentially less than or equal to 0.030, very preferentially less than or equal to 0.025 and extremely preferentially less than or equal to 0.022.

Thus, according to certain embodiments, the mole ratio of aromatic ether(s) relative to the total reaction solvent(s) introduced into the reaction medium is from 0.005 to 0.030, preferentially from 0.008 to 0.025, and extremely preferably from 0.010 to 0.022.

The mole ratio of aromatic ether(s) relative to the reaction solvent(s) introduced in total into the reaction medium may notably be from 0.011 to 0.022, from 0.012 to 0.022, from 0.013 to 0.022, from 0.014 to 0.022, from 0.015 to 0.022, from 0.016 to 0.022, or from 0.017 to 0.022.

The mole ratio of chain-limiting agent(s) relative to the aromatic ether(s) which have been introduced in total into the reaction medium may be from 0 to 0.12.

The process according to the invention initially involves placing in contact the chemical compounds involved in the polymerization reaction. This step notably involves placing in contact the reagents: aromatic ether(s), acyl chloride(s) and Lewis acid in a fraction s₁ of the reaction solvent, and optionally with all or some of a chain-limiting agent. These various compounds may theoretically be mixed together in any order.

For the purposes of the invention, the term “premix” is used from the moment when all or some of the aromatic ether(s), all or some of the acyl chloride(s) and all or some of the Lewis acid have been placed in contact in all or some of the reaction solvent fraction s₁ at a temperature T₀ less than or equal to 25° C. In other words, the “premix” begins to exist at the moment when polymerization may be thermodynamically initiated. However, polymerization is inhibited or at the very least remains extremely limited kinetically at T₀.

According to certain embodiments, T₀ is advantageously less than or equal to 15° C. It is more preferably less than or equal to 10° C. According to certain embodiments, it may be less than or equal to 8° C., or less than or equal to 5° C., or less than or equal to 0° C., or even less than or equal to −5° C.

According to certain embodiments, To may notably be in the temperature range from −10° C. to 15° C., and preferentially from −5° C. to 10° C.

The fraction s₁ of reaction solvent is calculated relative to the total reaction solvent used for performing the polymerization reaction. It corresponds to the fraction of solvent used during the placing in contact at T₀ relative to the total amount of reaction solvent used at the end of the polymerization. Specifically, in the process according to the invention, reaction solvent is added in various steps as described hereinbelow: in addition to using a fraction s₁ of reaction solvent to form the premix at T₀, a fraction s₂ of preheated reaction solvent is used to form the reaction mixture at T₁, and a fraction s₃ of reaction solvent may optionally be used for an optional step in which the reaction medium is brought to and maintained at a temperature T₂. This gives: s₁+s₂+s₃=1.

The fraction s₁ of the reaction solvent may be from 0.25 to 0.75.

The fraction of solvent s₁ may be from 0.25 to 0.35, or from 0.35 to 0.45, or from 0.45 to 0.55, or from 0.55 to 0.65, or from 0.65 to 0.75.

The solvent fraction s₁ will advantageously be chosen by a person skilled in the art as a function of the conditions available for performing the process. A sufficiently high value of s₁ notably allows sufficiently rapid placing in contact of the Lewis acid with the aromatic ether(s) and/or acid chloride(s) while at the same time maintaining the reaction medium at T₀. A sufficiently high value of s₁ also allows easy transfer, where appropriate, of the premix at T₀ to another reactor by gravity and/or pumping means. A sufficiently low value of s₁ notably allows sufficiently rapid placing in contact of the premix at T₀ with the fraction s₂ of preheated solvent while at the same time facilitating maintenance of the reaction medium at T₁.

The step of placing in contact to obtain the premix ends, or in other words the premix is formed, when all the aromatic ether or the mixture of aromatic ethers, the acyl chloride or the mixture of acyl chlorides, the Lewis acid and the fraction s₁ of the reaction solvent have been placed in contact. The premix formed may be maintained at T₀ for a certain time, for example to ensure good homogenization of the reaction medium.

Preferentially, the step of placing in contact to obtain the premix is performed with stirring.

For the purposes of the invention, when it is indicated that the placing in contact of the reagents to prepare the premix is performed at T₀ and/or that the premix formed is maintained at T₀, this does not presuppose that the temperature remains fixed, but means that the temperature of the reaction medium remains within the temperature range imposed for To.

The step of placing in contact to form the premix at T₀ generally lasts from 15 minutes to 12 hours. On an industrial scale, this step is preferentially from 25 minutes to 6 hours, and more preferably from 30 minutes to 4 hours.

Once the premix has been formed, the reaction medium may optionally be maintained at T₀ for less than an hour, and preferentially for 30 minutes or less. Once the premix has been formed at T₀, the reaction medium may optionally be maintained at T₀ for 15 minutes or less, or for 10 minutes or less, or for 5 minutes or less.

Preferentially, the premix formed is maintained at T₀ with stirring.

According to certain embodiments, the reaction medium is maintained at T₀ during the step of placing in contact and during the optional step of maintaining the formed premix for 15 minutes to 13 hours, preferentially for 25 minutes to 7 hours and more preferably for 30 minutes to 5 hours.

According to advantageous embodiments, the aromatic ether(s), acyl chloride(s) and Lewis acid may be added in two different phases to prepare the premix in the presence of the fraction s₁ of the reaction solvent. In a first phase, two of the reagents are mixed. In a second phase, the third reagent is added in its entirety to the mixture obtained previously, the reaction medium then being maintained at the temperature T₀ between at the latest the start of the second phase where the third reagent starts to be added and the end of the second phase where the third reagent stops being added.

According to a first embodiment, said first phase involves preparing a mixture comprising all of the aromatic ether or mixture of aromatic ethers with all of the acyl chloride or mixture of acyl chlorides, in the fraction s₁ of reaction solvent. The second phase involves adding all the Lewis acid to the mixture obtained in the first phase, the temperature of the reaction medium being maintained at T₀.

According to a second embodiment, said first phase involves preparing a mixture comprising all of the acyl chloride or the mixture of acyl chlorides with all of the Lewis acid, in the fraction s₁ of reaction solvent. The second phase involves adding all of the aromatic ether or mixture of aromatic ethers to the mixture obtained in the first phase, the temperature of the reaction medium being maintained at T₀.

The section below describes in detail these two particularly advantageous embodiments for performing the step of placing the chemical compounds in contact in a reactor. The process according to the invention is by no means limited to these illustrative embodiments.

Advantageously, the first embodiment is performed according to the following sequence:

Firstly, the fraction s₁ of the reaction solvent is introduced into the reactor. Secondly, the aromatic ether or mixture of aromatic ethers is added and dispersed in the reaction solvent in the reactor with stirring. Thirdly, in order to ensure that there are no traces of water in the reactor, distillation is performed and the reactor headspace is also inertized with nitrogen. Alternatively or additionally, a dehydrating agent, notably a small amount of aluminium chloride, may be added in order to eliminate the last traces of water. Fourthly, the acyl chloride or mixture of acyl chlorides is placed in the reactor with stirring. Fifthly, the Lewis acid is introduced with stirring. Since complexation of the Lewis acid with the acyl chloride(s) is an exothermic reaction, the Lewis acid is added to the reactor in a sufficiently slow manner so as to be able to maintain the premix at the temperature T₀. The Lewis acid addition step may last from 15 minutes to 12 hours. An optional step of homogenizing the formed premix at T₀ may be observed, where appropriate. This optional homogenization step may last 1 hour or less and preferentially 30 minutes or less.

The second advantageous embodiment may be performed according to the following sequence:

Firstly, the fraction s₁ of the reaction solvent is introduced into the reactor. Secondly, in order to ensure that there are no traces of water in the reactor, distillation is performed and the reactor headspace is also inertized with nitrogen. Alternatively or additionally, a dehydrating agent, notably a small amount of aluminium chloride, may be added in order to eliminate the last traces of water. Thirdly, the acyl chloride or mixture of acyl chlorides is placed in the reactor with stirring. Fourthly, the Lewis acid is introduced with stirring. Since complexation of the Lewis acid with the acyl chloride(s) is an exothermic reaction, the Lewis acid is added to the reactor sufficiently slowly so that the reaction mixture can be maintained at the temperature T₀. Fifthly, once all the Lewis acid has been fully introduced, the aromatic ether or mixture of aromatic ethers is introduced so as to form the premix. The aromatic ether addition step may last from 15 minutes to 12 hours. An optional step of homogenizing the formed premix at T₀ may be observed, where appropriate. This optional homogenization step may last 1 hour or less and preferentially 30 minutes or less.

The process according to the invention involves placing the premix formed in contact with a fraction s₂ of the reaction solvent, the fraction s₂ of the reaction solvent being preheated, to form a reaction mixture raised virtually instantaneously to a temperature T₁ ranging from 40° C. to 80° C. For the purposes of the invention, the term “reaction mixture” is used to denote the reaction medium in which all or some of the premix formed has been placed in contact with all or some of the fraction s₂ of preheated reaction solvent.

The polymerization reaction, which is non-existent or at least very limited kinetically at T₀, accelerates substantially at T₁. It is marked by a sudden increase in the heat flux emitted by the reaction mixture. It is also marked by a sudden increase in the production of hydrogen chloride. Finally, it is marked by a rapid increase in the viscosity of the reaction mixture.

T₁ is equal to 40° C. or more. Specifically, for temperatures below 40° C., there is excessive gel formation/fouling, which considerably reduces the yield of the process and/or the quality of the polymer obtained. T₁ may notably be greater than or equal to 42° C., or greater than or equal to 44° C., or greater than or equal to 46° C., or greater than or equal to 48° C.

According to certain embodiments, T₁ has a value of 40° C. to 50° C.

According to certain embodiments, T₁ has a value strictly greater than 40° C.

According to certain embodiments, T₁ has a value strictly greater than 50° C.

T₁ is equal to 80° C. or less. Specifically, for temperatures above 80° C., the polymer obtained comprises a high fraction of low mass molecules, even after purification. T₁ may notably be less than or equal to 78° C., or less than or equal to 76° C., or less than or equal to 74° C., or less than or equal to 72° C., or less than or equal to 70° C.

According to certain embodiments, T₁ has a value of 70° C. to 80° C.

According to certain embodiments, T₁ has a value strictly less than 80° C.

According to certain embodiments, T₁ has a value strictly less than 70° C.

According to certain embodiments, T₁ has a value from 50° C. to 60° C. In particular, T₁ may have a value from 52° C. to 60° C.

According to certain embodiments, T₁ has a value from 60° C. to 70° C. T₁ may notably have a value from 60° C. to 68° C.

The fraction s₂ of reaction solvent is calculated relative to the total amount of reaction solvent added at the end of polymerization. The fraction s₂ of the reaction solvent may be from 0.25 to 0.75.

The solvent fraction s₂ may be from 0.25 to 0.35, or from 0.35 to 0.45, or from 0.45 to 0.55, or from 0.55 to 0.65, or from 0.65 to 0.75.

According to certain embodiments, s₁+s₂≥0.75. Advantageously s₁+s₂≥0.85. It is notably possible to have s₁+s₂≥0.90 or s₁+s₂≥0.95.

According to particular embodiments, s₁+s₂=1, i.e. the entire reaction solvent has been introduced once the reaction mixture at T₁ is formed.

According to certain embodiments, s₁ ranges from 0.25 to 0.45, s₂ ranges from 0.55 to 0.75, and s₁+s₂≥0.75.

According to certain embodiments, s₁ ranges from 0.45 to 0.65, s₂ ranges from 0.35 to 0.55, and s₁+s₂≥0.75.

According to certain embodiments, s₁ ranges from 0.55 to 0.75, s₂ ranges from 0.25 to 0.45, and s₁+s₂≥0.75.

According to certain embodiments, Si ranges from 0.25 to 0.45, s₂ ranges from 0.55 to 0.75, and s₁+s₂=1.

According to certain embodiments, s₁ ranges from 0.45 to 0.65, s₂ ranges from 0.35 to 0.55, and s₁+s₂=1.

According to certain embodiments, s₁ ranges from 0.55 to 0.75, s₂ ranges from 0.25 to 0.45, and s₁+s₂=1.

Preferentially, the premix formed is gradually poured into all or some of the fraction s₂ of preheated reaction solvent at a rate adapted so that the temperature of the reaction medium remains within the temperature range imposed for T₁ to form the reaction mixture.

According to certain embodiments, the premix formed is gradually poured into the entire fraction s₂ of preheated reaction solvent. In this embodiment, the fraction s₂ of solvent is generally preheated to a temperature within the temperature range imposed for T₁. In order for the reaction mixture to remain within the temperature range imposed for T₁ to form the reaction mixture, an additional heat flow may be supplied by reactor heating and/or cooling means.

According to certain embodiments, the solvent fraction s₂ can be subdivided into two sub-fractions s₂′ and s₂′″, such that s₂=s₂′+s₂″. According to these embodiments, the premix formed may be gradually poured into the fraction s₂′ of preheated reaction solvent generally preheated to a temperature within the temperature range imposed for T₁. The solvent fraction s₂″ is preheated to a temperature higher than that of the fraction s₂′, for example to a temperature of 80° C. to 120° C., and is gradually poured, at the same time as the premix formed, into the reaction medium so that the reaction mixture remains within the temperature range imposed for T₁. In order for the reaction mixture to remain within the temperature range imposed for T₁ to form the reaction mixture, an additional heat flow may also be supplied by reactor heating and/or cooling means. Preferentially, s₂″≤s₂′.

The step of placing in contact to obtain the reaction mixture at T₁ ends, or in other words the reaction mixture is formed, when all of the premix at T₀ and the fraction s₂ of the reaction solvent have been placed in contact.

For the purposes of the invention, when it is indicated that the placing in contact of the premix formed with the fraction s₂ of solvent to obtain a reaction mixture at T₁ and/or that the reaction mixture formed is maintained at T₁, this does not presuppose that the temperature remains fixed, but means that the temperature of the reaction medium remains within the temperature range imposed for T₁. The reaction mixture formed may be maintained at T₁ for a certain time, for example to achieve a given degree of polymerization.

Preferentially, the step of placing in contact to obtain the reaction mixture at T₁ is performed with stirring so that the premix formed is suitably dispersed in the fraction of preheated reaction solvent. Advantageously, the stirring is performed with a dual-flow stirring system which keeps the reaction mixture in motion, notably at the level of the side walls of the reactor, and/or with the aid of a tank bottom turbine which keeps the reaction mixture in motion, notably at the level of the tank bottom wall, and thus prevents accelerated fouling of the reactor.

The step of placing in contact to form the reaction mixture at T₁ generally lasts from 15 minutes to 3 hours, and preferably from 25 minutes to 60 minutes.

Once the reaction mixture has been formed at T₁, the reaction medium can optionally be maintained at T₁ for 0 minutes to 6 hours, and preferably for 10 minutes to 60 minutes.

Preferentially, the reaction mixture formed is maintained at T₁ with stirring.

According to certain embodiments, the reaction mixture is maintained at T₁ during the step of placing in contact and during the optional step of maintaining the reaction mixture formed for 15 minutes to 8 hours, and preferably for 30 minutes to 120 minutes.

The reaction mixture can be maintained at T₁ during the step of placing the premix formed in contact with the fraction s₂ of preheated reaction solvent and optionally during the step of maintaining the formed reaction mixture at T₁ so as to achieve a certain degree of conversion of the polymerization reaction reagents. This degree of conversion can be assessed in various ways: determination of the monomers remaining in the reaction medium, measurement of the hydrogen chloride produced during the polymerization reaction, viscosity of the reaction medium, or assessment of the percentage fraction of molecular masses strictly below 500 g/mol as described below.

Preferentially, the reaction mixture is maintained at T₁ during the step of placing in contact the premix formed with the fraction s₂ of preheated reaction solvent and optionally during the step of maintaining the reaction mixture at T₁, until the percentage fraction of molecular masses strictly less than 500 g/mol in PMMA equivalent in the reaction mixture is less than or equal to 50%, preferably less than or equal to 25%, and more preferably less than or equal to 15%.

According to certain embodiments, the reaction mixture is maintained at T₁ during the step of placing the premix formed in contact with the fraction s₂ of preheated reaction solvent and during the step of maintaining at T₁ until the desired degree of polymerization is obtained.

According to certain embodiments, after formation of the reaction mixture at T₁ and optional maintenance of the reaction mixture at T₁, the reaction mixture may be brought to and maintained at T₂ for a certain period of time, T₂ being in the temperature range from a temperature at least 10° C. higher than T₁ to a temperature of 120° C., so as to achieve the desired degree of polymerization. To do this, an additional heat flow can be provided by reactor heating means and/or by adding a fraction s₃ of preheated reaction solvent, generally at a temperature in the range of temperatures imposed by T₂. This optional step makes it possible to achieve the desired degree of polymerization more quickly than in the embodiments in which the reaction mixture is only maintained at T₁. In these embodiments, T₂ preferentially ranges from 80° C. to 120° C., more preferably from 82° C. to 105° C., and extremely preferably from 85° C. to 95° C.

According to advantageous embodiments, the hydrogen chloride produced during the polymerization reaction is extracted from the reactor during polymerization so as to promote the polymerization reaction. To this end, all or some of the polymerization may be performed under reduced pressure, at an absolute pressure of less than or equal to 900 mbar, or less than or equal to 800 mbar, or less than or equal to 700 mbar, or less than or equal to 600 mbar, or less than or equal to 500 mbar, or less than or equal to 400 mbar, or less than or equal to 300 mbar, or less than or equal to 200 mbar, or less than or equal to 100 mbar. Alternatively, or additionally, an inert gas, for example helium, argon or dinitrogen, is bubbled into the reaction mixture. However, this method is not preferred as it creates additional turbulence in the reaction mixture and makes it more difficult to control the temperature within the reactor.

The process can be conducted in one reactor or a succession of several reactors.

In advantageous embodiments, the placing in contact to form the premix at T₀ and the placing in contact to form the reaction mixture at T₁ are performed in two separate reactors.

In embodiments in which the reaction mixture is then brought to T₂, this step can be performed in the same reactor as the one used for placing in contact to form the reaction mixture at T₁.

Reactors that can be used to perform the present invention may be, for example, glass reactors, enamelled reactors or reactors with corrosion-resistant metallurgy.

The reactors preferentially have temperature control means and means for measuring the temperature therein. The reactors may notably include one or more temperature sensors therein and be configured to cool and/or heat the medium they contain.

The reactors that may be used to perform the present invention are preferably equipped with a stirring device such as a mechanical stirrer (which may, for example, comprise one or more stirring rotors) or a recirculation loop with a pump.

The reactor that may be used to perform the step of forming the reaction mixture at T₁ advantageously has a dual-flow stirring system.

After the polymerization reaction has been completed to the desired degree of polymerization, the process of the invention may comprise purification of the polyether ketone ketone from the product mixture in a manner known per se. This has, for example, already been described in EP3655458.

In particular, this purification makes it possible to separate the solvent, the catalyst, the unreacted reagents and any reaction by-products from the polymer as such.

In particular, purification generally comprises a step of placing the product mixture in contact with a protic solvent, so as to recover a first phase comprising the Lewis acid and a second phase comprising the polyether ketone ketone.

The protic solvent may be an aqueous solution. The aqueous solution may simply be water. Alternatively, the aqueous solution may be an acidic solution, such as a hydrochloric acid solution. Preferably, the pH of the aqueous solution is not greater than 3, or not greater than 2. Dissociation of the polyether ketone ketone/Lewis acid complex is more efficient when an acidic solution is used.

Solvent mixtures may also be used, such as an aqueous-organic solvent, for example an aqueous solution mixed with methanol, ethanol, isopropanol or acetic acid. Preferentially, a mixture of an aqueous solution and an alcohol, notably methanol, ethanol or isopropanol, comprising 95% to 60% by weight, preferably 80% to 95% by weight of alcohol, is used.

Placing the product mixture in contact with the protic solvent produces a first phase (containing the protic solvent) and a second phase (containing the reaction solvent). The Lewis acid is mainly present in dissolved form in the first phase, whereas the polyether ketone ketone is mainly present in precipitated form in the second phase.

The polyether ketone ketone can then be recovered by solid/liquid separation of the second phase. Advantageously, the solid/liquid separation is performed by centrifugal filtration.

The dry solids content of the crude polyether ketone ketone product at the end of the solid/liquid separation step is preferably between 10% by weight and 90% by weight, more preferably between 15% and 75% by weight and even more preferably between 20% and 50% by weight.

The liquid effluents, containing the first phase and the second phase, can optionally be separated so as to be recovered separately, preferably by decantation, for possible reuse. A surfactant may be added in order to facilitate the phase separation. When the Lewis acid is aluminium trichloride, the first phase advantageously contains it in suitable proportions so that it can be directly recycled for use in a water treatment/sludge flocculation process.

According to preferred embodiments, the crude polyether ketone ketone product at the end of the preceding solid/liquid separation step can be further purified by washing with one or more protic solvents.

The protic solvent at this stage is preferably water or an aqueous solution. However, in other variants, the protic solvent at this stage may also be an organic solvent, optionally mixed with water. Linear or branched aliphatic alcohols such as methanol, ethanol and isopropanol are particularly preferred organic solvents. These organic solvents may optionally be mixed with each other and/or with water.

After the washing step or concomitantly with the washing step, a further solid/liquid separation step may be performed.

According to an advantageous embodiment, a centrifugal filtration device is used, so that washing and solid/liquid separation can be performed concomitantly in the device, without resuspension of the product.

After the final solid/liquid separation, the recovered solid is advantageously dried.

The drying step may be performed conventionally, for example at a temperature ranging from 100° C. to 280° C., and under atmospheric pressure or, preferably, under reduced pressure, for example at a pressure of 30 mbar. After drying, the polyether ketone ketone generally has a reaction solvent content of less than or equal to 50 ppm, preferentially less than or equal to 30 ppm, and more preferentially less than or equal to 15 ppm by weight, relative to the weight of polymer.

The polymer, which may be manufactured according to the process of the invention, generally has an inherent viscosity, measured at a concentration of 0.0005 g/mL in a 96.00% sulfuric acid solution, (mass fraction) at 25° C. using an Ubbelohde suspended level viscometer (inside diameter of the hair of 1.03 mm) according to the standard ISO 307-2009 applied to PEKK, of 0.4 to 2.0 dL/g, and preferentially of 0.75 to 1.45 dL/g.

According to certain embodiments, the polyether ketone ketone has an inherent viscosity of 0.75 to 0.85 dL/g, or 0.85 to 0.95 dL/g, or 0.95 to 1.05 dL/g, or 1.05 dL/g to 1.15 dL/g, or 1.15 to 1.25 dL/g, or 1.25 to 1.35 dL/g, or 1.35 to 1.45 dL/g.

The polyether ketone ketone, which may be manufactured according to the process of the invention, has the advantage of not generally containing any dispersant(s), notably those described in WO 9 523 821 and in US 2012/0263953, in the form of impurity(ies) (except in the less advantageous embodiments in which a dispersant is used). The polyether ketone ketone according to the invention thus generally does not comprise benzoic acid or a derivative thereof, used as dispersant, as described in US 2012/0263953. The polyether ketone ketone notably does not generally contain any of the following compounds: benzoic acid, methylbenzoic acid, sodium benzoate, magnesium benzoate, aluminium benzoate, methyl benzoate and benzenesulfonic acid. In particular, the polyether ketone ketone generally does not contain any benzoic acid. The polyether ketone ketone according to the invention thus also generally does not comprise any other polymer, used as dispersant, such as the polymers described in WO 9 523 821. The polyether ketone ketone notably does not generally contain any copolymers of aliphatic vinyl compounds and N-vinylpyrrolidone.

The polyether ketone ketone, which may be manufactured according to the process of the invention, consists of three molecular mass fractions A, B and C, in which A represents the percentage fraction of molecular masses strictly below 500 g/mol, B represents the percentage fraction of molecular masses ranging from 500 g/mol to 3000 g/mol, and C represents the percentage fraction of molecular masses strictly above 3000 g/mol, in PMMA equivalent.

This gives A+B≤5.0% and A+B+C=100%.

Preferentially, A≤1.0%. Very low molecular weight molecules may be eliminated to very low contents by more or less sophisticated methods known to those skilled in the art. For example, an azeotropic distillation method has been described in WO 2014/013202. Preferentially, notably by means of using such methods, A≤0.5%, or even A≤0.3%.

Preferentially, B≤4.0%. Low molecular weight molecules are difficult to eliminate using even advanced and/or sophisticated extraction methods (see Example 3). According to advantageous embodiments, the process according to the invention allows B≤3.5%, and preferably B≤3.2%, to be achieved.

According to certain advantageous embodiments, B≤3.2, or B≤3.1, or B≤3.0, or B≤2.9, or B≤2.8, or B≤2.7, or B≤2.6, or B≤2.5, or B≤2.4, or B≤2.3, or B≤2.2, or B≤2.1, or B≤ 2.0 may be achieved.

The advantage of such polymers with a low B fraction is that they can be extruded, notably granulated, and allow objects derived therefrom to be obtained which have few defects, notably few black dots.

According to certain embodiments, notably when T₁ ranges from 68° C. to 80° C., B≤3.8%, preferentially B≤3.5%, and more preferably B≤3.2% is achieved.

According to certain embodiments, notably when T₁ ranges from 60° C. to 68° C., B≤3.2%, or B≤3.1%, or B≤3.0%.

According to certain embodiments, notably when T₁ ranges from 52° C. to 60° C., B≤3.0%, or B≤2.9%, or B≤2.8%.

According to certain embodiments, notably when T₁ ranges from 40° C. to 52° C., B≤2.8%, or B≤2.7%, or B≤2.6%.

The polyether ketone ketone obtained according to the process of the invention is generally in the form of flakes of fairly homogeneous size forming a powder. In particular, and advantageously, the polymer has few large flakes. This is notably advantageous for facilitating purification. Specifically, the extraction of aluminium chloride and/or impurities resulting from polymerization is simpler and more efficient to perform on particles of reduced size. In addition, drying can also be performed more quickly. Moreover, it is easier to feed equipment for grinding, screening, compacting, granulating and extruding such a powder.

Advantageously, the polyether ketone ketone powder according to the invention has a mass proportion of particles with a size strictly greater than 1000 micrometres of less than or equal to 50%, relative to the total weight of the particles of the powder, as obtained by screening using a mesh size equal to 1 millimetre.

According to certain embodiments, the polyether ketone ketone powder according to the invention has a mass proportion of particles with a size strictly greater than 1000 micrometres of less than or equal to 25%.

According to certain embodiments, the mass proportion of particles with a size strictly greater than 1000 micrometres is less than or equal to 15%, preferentially less than or equal to 10%, and extremely preferably less than or equal to 5%.

According to certain embodiments, the mass proportion of particles ranging in size from 315 micrometres to 1000 micrometres is greater than or equal to 50%, as obtained by successive screening using a screen with a mesh size equal to 1 millimetre and a screen with a mesh size equal to 315 micrometres. Preferentially, the mass proportion of particles with a size ranging from 315 micrometres to 1000 micrometres may be greater than or equal to 80%. According to these embodiments, the mass proportion of particles with a size strictly less than 315 micrometres is advantageously less than or equal to 10% and the mass proportion of particles with a size strictly greater than 1000 micrometres is less than or equal to 10%.

According to certain embodiments, the mass proportion of particles with a size strictly less than 630 micrometres is greater than or equal to 50%, preferentially greater than or equal to 70%, and more preferably greater than or equal to 85%.

According to certain embodiments, the polyether ketone ketone flakes, forming a powder, have a tapped density greater than or equal to 180 kg/m³. Preferentially, the polyether ketone ketone flakes, forming a powder, have a tapped density of greater than or equal to 200 kg/m³. A sufficiently high tapped density has several advantages depending on the intended use. In granulation, it reduces the amount of air introduced into the extruder and improves the melt stability of the polymer. In laser sintering, after grinding into a fine powder, it improves the cohesion of the powder bed. The tapped density generally remains less than 400 kg/m³. It may notably be less than 350 kg/m³, or even less than or equal to 300 kg/m³, or even less than or equal to 250 kg/m³.

### Measurement Methods

The following measurement methods apply to the invention and have notably been used in the examples presented hereinbelow.

### Determination of the Fractions A, B and C

About 30 mg of polymer composition to be evaluated are placed in 1 ml of 4-chlorophenol for 2 hours at 150° C. After the solution has cooled to room temperature, 14 ml of hexafluoroisopropanol (HFIP) are added, and the solution is then filtered through an Acrodisc syringe filter comprising a polytetrafluoroethylene (PTFE) membrane with a diameter of 25 mm and a porosity of 0.2 μm. The molar masses of the resin in the sample are determined by size exclusion chromatography using a Waters Alliance 2695 type instrument under the conditions below:
Flow rate: 1.00 ml/min. Eluent: HFIP. Volume injected: 100.00 μl. Set of PSS PFG columns (1000+100 Å) 25 2×30 cm. Temperature 40° C. Detection method: differential refractometer.
Calibration: PMMA with a molecular mass range from 402 g/mol to 1 900 000 g/mol to be updated for each series of analyses.

The chromatogram baseline and integration were produced in accordance with the recommendations of the standard ISO 16014-1:2019, namely:
the start of the baseline is generally set at an elution volume of between 0 and 10 mL (Vi),
the end of the baseline is generally set at an elution volume of between 30 and 40 mL (Vf).

The chromatogram integration (area) starts when the signal differs from the 0 level defined by the baseline, called (Va). The chromatogram integration (area) ends before the system peak, i.e. generally at an elution volume corresponding to a mass of between 50 and 200 g/mol in PMMA equivalent (Vb). The integration of masses less than 500 g/mol begins at the elution volume corresponding to a molar mass of 500 g/mol in PMMA equivalent (V500) and ends at the final integration of the chromatogram, i.e. Vb. The integration of masses less than 3000 g/mol begins at the elution volume corresponding to a molar mass of 3000 g/mol in PMMA equivalent (V3000) and ends at the final integration of the chromatogram, i.e. Vb.

The determination of the molar mass fraction strictly less than 500 g/mol (in PMMA equivalent), noted in the invention as fraction A and expressed in %, is determined by taking the ratio of the integration area of the molar masses between 0 and 500 g/mol and the integration area of the total chromatogram, according to the calculation below:

$$\% M < 500 g . {mol}^{- 1} = \frac{{Area}_{( Vb - V 500 )}}{{Area}_{( Vb - Va )}} \cdot 100$$

The determination of the molar mass fraction ranging from 500 g/mol (in PMMA equivalent) to 3000 g/mol (in PMMA equivalent), noted in the invention as fraction B and expressed in %, is determined by performing the following calculation:

$$500 g . {mol}^{- 1} \leq \% M \leq 3000 g . {mol}^{- 1} = \frac{{Area}_{( V 500 - V 3000 )}}{{Area}_{( Vb - Va )}} \cdot 100$$

The determination of the molar mass fraction strictly greater than 3000 g/mol (in PMMA equivalent), noted in the invention as fraction C and expressed in %, is determined by performing the following calculation:

$$\% M > 300 g . {mol}^{- 1} = 100 - fraction A - fraction B$$

### Measurement of the Inherent Viscosity

The inherent viscosity ηᵢₙₕ was measured at a concentration of 0.0005 g/mL in a 96.00% sulfuric acid solution at 25° C. using an Ubbelohde type suspended level viscometer according to the standard ISO 307-2009.

### Determination of the Particle Size Distribution

The particle size distribution was evaluated by screening on sieves with a mesh size equal to the indicated limit value (315 μm, 630 μm, 800 μm and 1000 μm).

### Measurement of the Tapped Density

The tapped density was measured according to the standard ISO 1068-1975 (F) in the following manner:
The powder is conditioned for 24 hours at 23° C. and 50% RH.
A volume of powder is introduced into an accurate graduated 250 ml glass measuring cylinder;
If necessary, the free surface of the powder is levelled off, without tapping it, and the volume V0 is recorded;
   volume V0;
The measuring cylinder with the powder is weighed on a balance with an accuracy of 0.1 g, which has been tared beforehand;
The measuring cylinder is placed on the plate of the STAV 2003 tapping machine;
It is tapped by dropping 1250 times, and the volume V1 is recorded;
It is tapped by dropping 1250 times, and the volume V2 is recorded;
The tapping operation is repeated until two equivalent volumes Vi are obtained.
Vf corresponding to the identical volumes Vi is recorded.

The tapped density is the mass of powder introduced divided by Vf. It is expressed in kg/m³.

### EXAMPLES

### Example 1

Two jacketed reactors (R1 and R2), each connected to a heat regulation system using a suitable for heat transfer liquid and each equipped with a stirring means and a system for inertizing under a flow of nitrogen in the headspace, were used.

In reactor R1, with glycol-water as heat transfer liquid, the premix was prepared as follows: ortho-dichlorobenzene and 1,4-bis(4-phenoxybenzoyl)benzene were first added with stirring in a 1,4-bis(4-phenoxybenzoyl)benzene/ortho-dichlorobenzene mass proportion equal to 0.128 (fraction s1=0.68). A mixture of terephthaloyl and isophthaloyl chlorides, in a mole ratio of terephthaloyl chloride to isophthaloyl chloride equal to 0.77, was then added with stirring to the reaction medium so that the total amount of isophthaloyl chloride and terephthaloyl chloride was in a substantially equimolar amount relative to the 1,4-bis(4-phenoxybenzoyl)benzene (mole ratio of 1,4-bis(4-phenoxybenzoyl)benzene relative to the mixture of terephthaloyl and isophthaloyl chlorides equal to 1.03). Benzoyl chloride was also added with stirring as chain limiter in a mole ratio relative to the 1,4-bis(4-phenoxybenzoyl)benzene equal to 0.042. The reaction medium in reactor R1 was then cooled to −5° C. Solid aluminium trichloride was added over about 1 hour, with stirring, to form a premix, the temperature of the premix being maintained at about −5° C. throughout the step of adding the aluminium trichloride. The mole ratio of aluminium trichloride relative to the 1,4-bis(4-phenoxybenzoyl)benzene is equal to 6.3. Once the aluminium trichloride had been added, the temperature of the premix in R1 was maintained at about −5° C. for 30 minutes.

At the same time, ortho-dichlorobenzene was added in a mass proportion of 1,4-bis(4-phenoxybenzoyl)benzene of the premix relative to the ortho-dichlorobenzene in R2 equal to 0.060 (fraction s₂=0.32) to reactor R2, which had an oil as heat transfer liquid and which was equipped with a stirring system with two stirring rotors, and heated to a temperature of 55° C. (test #1), 65° C. (test #2) or 90° C. (test #3, comparative). The premix in R1 at 0° C. was gradually transferred using a pump into reactor R2 with stirring and maintained at 55° C. (test #1), 65° C. (test #2) and 90° C. (test #3, comparative). The transfer operation lasted 30 minutes. The reaction mixture formed was then maintained at 55° C. (test #1), 65° C. (test #2) and 90° C. (test #3, comparative) for 10 minutes, 10 minutes and 40 minutes, respectively.

For tests #1 and #2, the temperature in reactor R2 was then increased rapidly until a temperature of 90° C. was reached. The reaction mixture was then maintained at a temperature of 90° C. for 30 minutes.

For tests #1, #2 and #3, the product mixture was finally cooled to a temperature of about 50° C. It was purified by mixing with an aqueous hydrochloric acid solution with a pH≤3 and solid/liquid separation using a filter. The crude polymer was then washed three times by resuspension and then filtration, the washing solutions used successively being methanol, a 3 vol % hydrochloric acid solution and water.

The purified polymer was finally dried at 180° C. for 24 hours under vacuum (30 mbar).

The determination of fractions A, B and C and also the measurement of the inherent viscosity for the polymer composition obtained for each test are presented in Table 1 below:

TABLE 1

| | | | | | | Frac- | |
|---|---|---|---|---|---|---|---|
| | | | | | | tion A + | |
| | | | Tapped | Frac- | Frac- | Frac- | Frac- |
| | T₁ | ηᵢₙₕ | density | tion | tion | tion B | tion C |
| Test | (° C.) | (dL/g) | (kg/m³) | A (%) | B (%) | (%) | (%) |
| #1 | 55 | 0.88 | 214 | 0.8 | 2.8 | 3.6 | 96.4 |
| #2 | 65 | 0.85 | 192 | 0.9 | 3.0 | 3.9 | 96.1 |
| #3 | 90 | 0.79 | 170 | 1.1 | 4.1 | 5.2 | 94.8 |

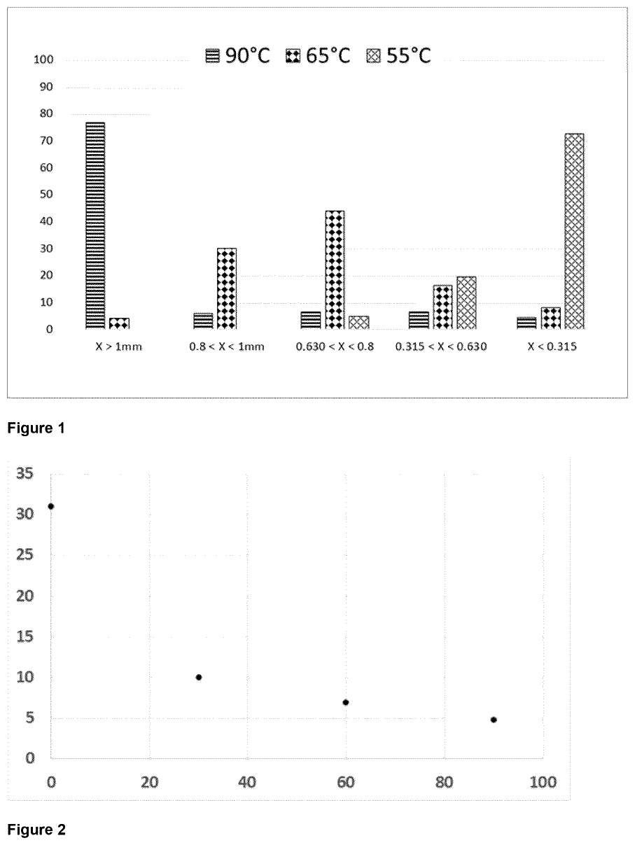

The particle size distribution for each test is plotted on the graph in FIG. 1.

In the light of the results presented in Table 1, it may be concluded that the polymers according to Examples #1 and #2 have fewer low molecular weight molecules, notably fewer molecules with a molecular weight of less than or equal to 3000 g/mol, and notably fewer molecules with a molecular weight of 500 g/mol to 3000 g/mol, than the polymer according to Comparative Example #3.

In the light of the results shown in FIG. 1, it may be concluded that the powder according to Examples #1 and #2 is a submillimetre-sized powder, with a fairly homogeneous particle size distribution, unlike the powder according to Comparative Example #3, which is a powder with particle sizes of the order of a millimetre and a very inhomogeneous particle size distribution.

### Example 2

The kinetics of the polymerization reaction were studied at 65° C. by preparing the premix at T₀ as in Example 1. At the same time, ortho-dichlorobenzene was added to reactor R2, having an oil as heat transfer liquid and equipped with a dual-flow stirring system, in a mass ratio of 1,4-bis(4-phenoxybenzoyl)benzene of the premix relative to ortho-dichlorobenzene in R2 equal to 0.060 (fraction s₂=0.32) and heated to a temperature of 65° C. The premix in R1 at 0° C. was gradually transferred using a pump into reactor R2 with stirring and maintained at 65° C. The transfer operation lasted 30 minutes. The reaction mixture formed was then maintained at 65° C. for 90 minutes and samples of the reaction medium were taken up and analysed for different maintenance times in order to determine fraction A (see FIG. 2).

In the light of FIG. 2, it can be deduced that for test #2, according to Example 1, the step of placing in contact to form the premix and maintaining at T1 allows the reaction medium to reach a fraction A of less than about 20% for a maintenance time of 10 minutes. This shows that although polymerization can be maintained at T1 until the desired degree of polymerization is reached, it may be advantageous to increase the temperature of the reaction medium to a temperature T2 so as to reach the desired degree of polymerization more quickly while at the same time benefiting from the technical advantages of the invention (low proportion of low molecular weight molecules and powder morphology).

### Example 3

An extraction test on fraction B of the polymer obtained according to test #3 was performed in dichloromethane with stirring for 144 hours at 35° C. The mixture of the polymer and of the extraction dichloromethane was then drained, washed in-situ with dichloromethane, then washed with water at 30° C., and finally dried.

The polymer thus extracted had a B fraction of 3.81%. This shows that even under fairly rigorous extraction conditions, it is substantially impossible to extract low mass molecules, notably those with a molecular weight of between 500 g/mol and 3000 g/mol.

1. Process for manufacturing a polyether ketone ketone, involving:
placing in contact an aromatic ether which is diphenyl ether, 1,3-bis(4-phenoxybenzoyl)benzene, 1,4-bis(4-phenoxybenzoyl)benzene or a mixture thereof, an acyl chloride which is isophthaloyl chloride, terephthaloyl chloride, or a mixture thereof, a Lewis acid, and a first fraction s₁ of a reaction solvent, so as to form a premix at a temperature T₀ less than or equal to 25° C.;
optionally, maintenance of the formed premix at T₀;
placing in contact the formed premix at T₀ with a fraction s₂ of the reaction solvent, the fraction s₂ of reaction solvent being preheated, so as to form a reaction mixture brought to a temperature T₁ ranging from 40° C. to 80° C.; and
optionally maintaining the formed reaction mixture at T₁.

2. Process according to claim 1, in which the reaction solvent is chosen from the group consisting of: ortho-dichlorobenzene, 1,2,4-trichlorobenzene, 1,2,3-trichlorobenzene, ortho-difluorobenzene, and mixtures thereof.

3. Process according to either of claims 1 and 2, in which the reaction solvent is ortho-dichlorobenzene.

4. Process according to any one of claims 1 to 3, in which the Lewis acid is chosen from the group consisting of: aluminium trichloride, aluminium tribromide, antimony pentachloride, antimony pentafluoride, indium trichloride, gallium trichloride, boron trichloride, boron trifluoride, zinc chloride, ferric chloride, stannic chloride, titanium tetrachloride and molybdenum pentachloride, and mixtures thereof.

5. Process according to any one of claims 1 to 4, in which the Lewis acid is aluminium trichloride.

6. Process according to any one of claims 1 to 5, in which the aromatic ether consists essentially of, or consists of, 1,4-bis(4-phenoxybenzoyl)benzene.

7. Process according to any one of claims 1 to 6, in which s₂≥0.25.

8. Process according to any one of claims 1 to 7, in which s₁≥0.25.

9. Process according to any one of claims 1 to 8, in which s₁+s₂≥0.75.

10. Process according to any one of claims 1 to 9, in which s₁+s₂=1.

11. Process according to any one of claims 1 to 10, in which T₁ ranges from 40° C. to 52° C.

12. Process according to any one of claims 1 to 10, in which T₁ ranges from 52° C. to 60° C.

13. Process according to any one of claims 1 to 10, in which T₁ ranges from 60° C. to 68° C.

14. Process according to any one of claims 1 to 10, in which T₁ ranges from 68° C. to 80° C.

15. Process according to any one of claims 1 to 14, in which the reaction mixture is brought to and optionally maintained at T₁ until the reaction mixture formed has a fraction of molecular masses strictly less than 500 g/mol in PMMA equivalent which is less than or equal to 50%, preferentially less than or equal to 25%, and even more preferentially less than or equal to 15%.

16. Process according to any one of claims 1 to 15, in which the reaction medium is brought to and optionally maintained at a temperature T₂ ranging from a temperature at least 10° C. higher than T₁ to 120° C., after the step of forming and optionally maintaining the reaction mixture at the temperature T₁.

17. Process according to any one of claims 1 to 16, comprising a step of purifying the mixture of products obtained at the end of polymerization.

18. Process according to any one of claims 1 to 17, in which a chain-limiting agent is added before the step of forming the reaction mixture brought to a temperature T₁.

19. Process according to any one of claims 1 to 18, in which the mole ratio of aromatic ether(s) relative to the reaction solvent which has been introduced in total into the reaction mixture is: from 0.005 to 0.030, preferentially: from 0.008 to 0.025 and very preferably: from 0.010 to 0.022.

20. Process according to any one of claims 1 to 19, in which the premix formed at T₀ is dispersed in all or part of the fraction s₂ of the preheated reaction solvent to form the reaction mixture brought to T₁.

21. Process according to any one of claims 1 to 20, in which the step of placing the premix in contact with the fraction s₂ of reaction solvent is performed with stirring, and preferentially using a dual flow stirring means.

22. Process according to any one of claims 1 to 21, in which the polyether ketone ketone obtained via the process consists of repeating units of formula (I) and of formula (II), the ratio of units of formula (II) relative to the units of formula (I) being from 55:45 to 95:5, the unit of formula (I) having the chemical formula: 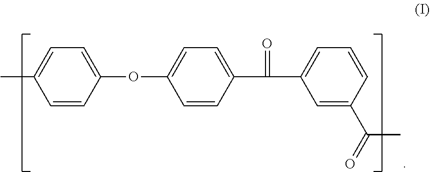
and the unit of formula (II) having the chemical formula:

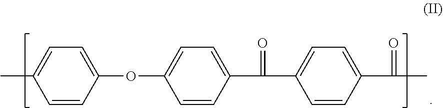

23. Polyether ketone ketone consisting of three molecular mass fractions A, B and C, in which A represents the percentage fraction of molecular masses strictly below 500 g/mol in PMMA equivalent, B represents the percentage fraction of molecular masses ranging from 500 g/mol to 3000 g/mol in PMMA equivalent, and C represents the percentage fraction of molecular masses strictly above 3000 g/mol in PMMA equivalent, characterized in that: A+B≤5.0% and A+B+C=100%.

24. Polyether ketone ketone according to claim 23, in which B≤4.0%, preferentially B≤ 3.5%, and more preferably B≤3.3%.

25. Polyether ketone ketone according to either of claims 23 and 24, having an inherent viscosity of greater than or equal to 0.4 dl/g, preferentially greater than or equal to 0.5 dl/g, preferentially greater than or equal to 0.6 dl/g, and more preferentially greater than or equal to 0.7 dl/g; and/or
having an inherent viscosity of less than or equal to 2 dl/g and preferentially less than or equal to 1.5 dl/g;
the inherent viscosity being measured at a concentration of 0.0005 g/mL in a 96.00% sulfuric acid solution at 25° C. using an Ubbelohde type suspended level viscometer according to the standard ISO 307-2009.

26. Polyether ketone ketone according to any one of claims 23 to 25, consisting of repeating units of formula (I) and of formula (II), the ratio of units of formula (II) relative to the units of formula (I) being from 55:45 to 95:5, the unit of formula (I) having the chemical formula: 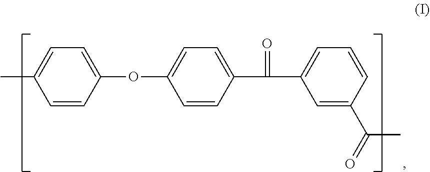
and the unit of formula (II) having the chemical formula:

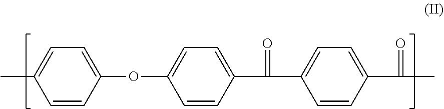

27. Polyether ketone ketone according to any one of claims 23 to 26, not comprising any dispersant.

28. Polyether ketone ketone powder according to any one of claims 23 to 27, for which the mass proportion of particles with a size strictly greater than 1000 micrometres is less than or equal to 50%, as obtained by screening using a sieve with a mesh size equal to 1 millimetre.

29. Polyether ketone ketone powder according to claim 28, for which the mass proportion of particles ranging in size from 315 micrometres to 1000 micrometres is greater than or equal to 50%, and preferentially greater than or equal to 80%.

30. Polyether ketone ketone powder according to either of claims 28 and 29, for which the mass proportion of particles with a size strictly greater than 1000 micrometres is less than or equal to 10%, and preferentially less than or equal to 5%.

31. Polyether ketone ketone powder according to one of claims 28 to 30, for which the mass proportion of particles with a size strictly less than 315 micrometres is less than or equal to 10%.

32. Polyether ketone ketone powder according to claim 28, for which the mass proportion of particles strictly smaller than 630 micrometres is greater than or equal to 50%, preferentially greater than or equal to 70%, and more preferably greater than or equal to 85%.

33. Polyether ketone ketone powder according to any one of claims 28 to 32, having a tapped density of greater than or equal to 180 kg/m³ and less than or equal to 400 kg/m³.

34. Polyether ketone ketone according to any one of claims 22 to 27 or powder according to any one of claims 28 to 33, obtained according to the process according to any one of claims 1 to 22.
